(19) United States
(12) Patent Application Publication
(10) Pub. No.: US 2024/0394523 A1
(43) Pub. Date: Nov. 28, 2024

(54) SAMPLING ARTIFICIAL NEURAL NETWORKS

(71) Applicant: National Technology & Engineering Solutions of Sandia, LLC, Albuquerque, NM (US)

(72) Inventors: James Bradley Aimone, Keller, TX (US); John Darby Smith, Albuquerque, NM (US)

(21) Appl. No.: 18/201,222

(22) Filed: May 24, 2023

(51) Int. Cl. G06N 3/063; G06N 3/047

(52) U.S. Cl. CPC G06N 3/063; G06N 3/047

(57) ABSTRACT

Sampling an artificial neural network is provided. The method comprises creating a number of sample matrices based on a weight matrix of a trained artificial neural network, wherein each element in the sample matrices is equal to one of a pair of numbers generated by stochastic neuromorphic hardware according to weights from the weight matrix corresponding to the elements in the sample matrices. A number of inferences are performed with the trained neural network, wherein the weight matrix of the trained neural network is replaced with the sample matrices, and wherein each inference is performed with a different one of the sample matrices. A confidence level of the inferences is determined according to deviations between the first choice and other choices made by the trained neural network across the inferences.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to artificial neural networks and to systems and methods for sampling an artificial neural network to provide a probabilistic estimate of the output of the network.

### 2. Background

Artificial neural networks are computing systems inspired by the biological networks that constitute animal brains. An artificial neural network comprises a collection of connected units or nodes called artificial neurons. An artificial neuron in an artificial neural network may receive a number of signals from input to the artificial neural network or from other artificial neurons in the artificial neural network. The artificial neuron then processes the received signals to generate an output signal. The output signal from the artificial neuron is provided to other artificial neurons that are connected to it in the artificial neural network or to the output of the artificial neural network itself.

It is well known that sampling neural networks during training (such as with Dropout) is very effective at providing a robust training that mitigates the impact of overfitting. Dropout is an example of neural sampling, whereby neurons are randomly removed in training, pushing learning in each epoch to a different subset of neurons. There is also a process of synapse dropout, which is implicit in neuron dropout (all neurons removed by definition have their synapses removed for those training epochs) but would be more finely administered.

Therefore, it would be desirable to have a method and apparatus that take into account at least some of the issues discussed above, as well as other possible issues.

### SUMMARY

An illustrative embodiment provides a computer-implement method of sampling an artificial neural network. The method comprises creating a number of sample matrices based on a weight matrix of a trained artificial neural network, wherein each element in the sample matrices is equal to one of a pair of numbers generated by stochastic neuromorphic hardware according to weights from the weight matrix corresponding to the elements in the sample matrices. A number of inferences are performed with the trained neural network, wherein the weight matrix of the trained neural network is replaced with the sample matrices, and wherein each inference is performed with a different one of the sample matrices. A confidence level of the inferences is determined according to deviations between the first choice and other choices made by the trained neural network across the inferences.

Another illustrative embodiment provides a system for sampling an artificial neural network. The system comprises a storage device configured to store program instructions, and one or more processors operably connected to the storage device and configured to execute the program instructions to cause the system to: create a number of sample matrices based on a weight matrix of a trained artificial neural network, wherein each element in the sample matrices is equal to one of a pair of numbers generated by stochastic neuromorphic hardware according to weights from the weight matrix corresponding to the elements in the sample matrices; perform a number of inferences with the trained neural network, wherein the weight matrix of the trained neural network is replaced with the sample matrices, and wherein each inference is performed with a different one of the sample matrices; and determine a confidence level of the inferences according to deviations between the first choice and other choices made by the trained neural network across the inferences.

Another illustrative embodiment provides a computer program product for sampling an artificial neural network. The computer program product comprises a computer-readable storage medium having program instructions embodied thereon to perform the steps of: creating a number of sample matrices based on a weight matrix of a trained artificial neural network, wherein each element in the sample matrices is equal to one of a pair of numbers generated by stochastic neuromorphic hardware according to weights from the weight matrix corresponding to the elements in the sample matrices; performing a number of inferences with the trained neural network, wherein the weight matrix of the trained neural network is replaced with the sample matrices, and wherein each inference is performed with a different one of the sample matrices; and determining a confidence level of the inferences according to deviations between the first choice and other choices made by the trained neural network across the inferences.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a neural network sampling system in accordance with an illustrative embodiment;

FIG. 2 depicts a diagram illustrating a node in a neural network with which illustrative embodiments can be implemented;

FIG. 3 depicts a diagram illustrating a neural network in which illustrative embodiments can be implemented;

FIG. 4 depicts a diagram of a stochastic magnetic tunnel junction in accordance with an illustrative embodiment;

FIG. 5 depicts a diagram of a stochastic tunnel diode in accordance with an illustrative embodiment;

FIG. 6 depicts a diagram of a confusion matrix of first inference choices in accordance with an illustrative embodiment;

FIG. 7 depicts a diagram of a confusion matrix of second inference choices in accordance with an illustrative embodiment;

FIG. 8 depicts a diagram comparing deterministic and inference accuracy in accordance with an illustrative embodiment;

FIG. 9 depicts a diagram of wrong inference choices in accordance with an illustrative embodiment;

FIG. 10 depicts a flowchart illustrating a process for sampling a trained neural network in accordance with illustrative embodiments; and

FIG. 11 is a diagram of a data processing system depicted in accordance with an illustrative embodiment.

### DETAILED DESCRIPTION

The illustrative embodiments recognize and take into account one or more different considerations. For example, the illustrative embodiments recognize and take into account that it is well known that sampling neural networks during training (such as with Dropout) is very effective at providing a robust training that mitigates the impact of overfitting. Dropout is an example of neural sampling, whereby neurons are randomly removed in training, pushing learning in each epoch to a different subset of neurons. There is also a process of synapse dropout, which is implicit in neuron dropout (all neurons removed by definition have their synapses removed for those training epochs) but would be more finely administered.

The illustrative embodiments also recognize and take into account that it is less immediately obvious whether there is a value of sampling neural networks during inference. In the case of inference, the value is not one of regularization but rather one of assessing the uncertainty inherent in a network through a sampling process. Because of its scale, neuron dropout during inference is disruptive. However, it is possible that a process similar to synapse dropout may be more suitable for inference mode.

The illustrative embodiments also recognize and take into account that at first glance, it is not immediately apparent that the value of synaptic sampling a trained neural network outweighs the costs. If a network can be trained to provide in one-pass a good answer or prediction, why would one want to sample that network hundreds, or even thousands, of times? Each sample will be less accurate than the deterministic network, and it is not obvious that in aggregate the accuracy will be higher. Further, the computational cost of sampling is high, with inference costs already being a complicating factor for neural networks.

The illustrative embodiments provide a method sampling a trained neural network. The illustrative embodiments employ a variant of artificial neural networks in which the connections (i.e., weights, synapses) between neurons are entirely probabilistic, and the network itself is sampled to provide a probabilistic estimate of the output of the network.

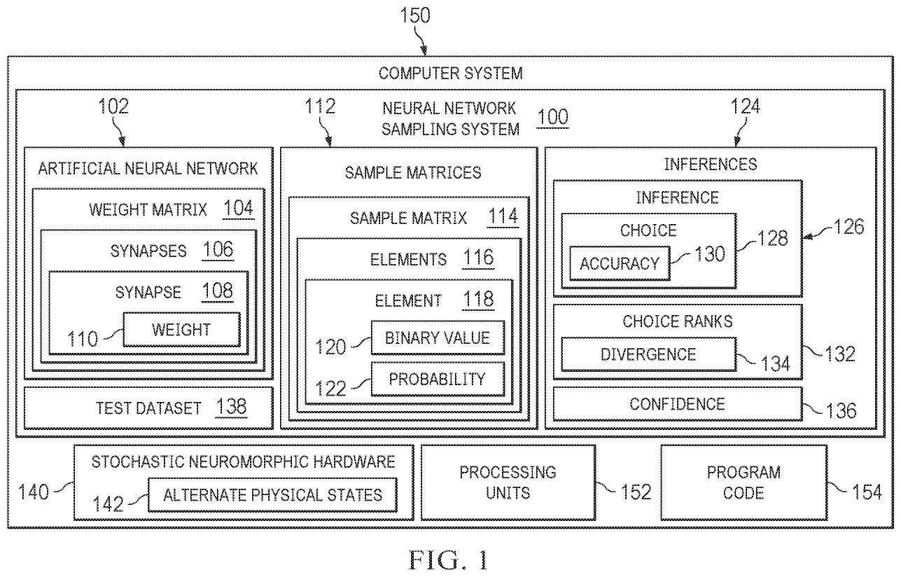

FIG. 1 depicts a block diagram of a neural network sampling system in accordance with an illustrative embodiment. Neural network sampling system 100 performs synaptic sampling on an artificial neural network 102. Artificial neural network 102 is a trained neural network that has an associated weigh matrix 104 that represents the synapses 106 comprising the artificial neural network 102. Each synapse 108 has a corresponding weight 110.

To sample artificial neural network 102, neural network sampling system 100 creates a number of sample matrices 112 that are substituted in place of the weight matrix 104 during subsequent inferences 124. Each sample matrix 114 comprises a number of elements 116 corresponding to the synapses 106 in the weight matrix 104. Each element 118 has a respective binary value 120, which comprises one of any pair of distinct numbers, e.g., 1 or 0, −1 or +1. This binary value 120 is generated by stochastic neuromorphic hardware 142, which is able to assume one of two alternate physical states 142 (e.g., high resistance/low resistance). The stochastic neuromorphic hardware 140 assigns the binary value 120 to element 118 according to a probability 122 based on the corresponding weight 110 in the weight matrix 104.

Neural network sampling system 100 employs sample matrices 112 while performing a number of inferences 124 with the trained artificial neural network 102. Each inference 126 uses a different sample matrix 114 to make a choice 128. The choice 128 has an accuracy 130 that can be determined relative to labeled test dataset 138.

The choices derived by the inferences 124 are aggregated and assigned choice ranks 132. Within the choice ranks 132 is a divergence 134 that neural network sampling system 100 uses to establish a confidence 136 of the first choice within choice ranks 132. For example, if the first choice is very accurate vis a vis the test dataset 138 but the second and third highest choices are dramatically different from the first choice, the confidence in that first choice will be lower than if the next highest choices are closer to the first.

Neural network sampling system 100 can be implemented in software, hardware, firmware, or a combination thereof. When software is used, the operations performed by neural network sampling system 100 can be implemented in program code configured to run on hardware, such as a processor unit. When firmware is used, the operations performed by neural network sampling system 100 can be implemented in program code and data and stored in persistent memory to run on a processor unit. When hardware is employed, the hardware can include circuits that operate to perform the operations in neural network sampling system 100.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 150 is a physical hardware system and includes one or more data processing systems. When more than one data processing system is present in computer system 150, those data processing systems are in communication with each other using a communications medium. The communications medium can be a network. The data processing systems can be selected from at least one of a computer, a server computer, a tablet computer, or some other suitable data processing system.

As depicted, computer system 150 includes a number of processor units 152 that are capable of executing program code 154 implementing processes in the illustrative examples. As used herein a processor unit in the number of processor units 152 is a hardware device and is comprised of hardware circuits such as those on an integrated circuit that respond and process instructions and program code that operate a computer. When a number of processor units 152 execute program code 154 for a process, the number of processor units 152 is one or more processor units that can be on the same computer or on different computers. In other words, the process can be distributed between processor units on the same or different computers in a computer system. Further, the number of processor units 152 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

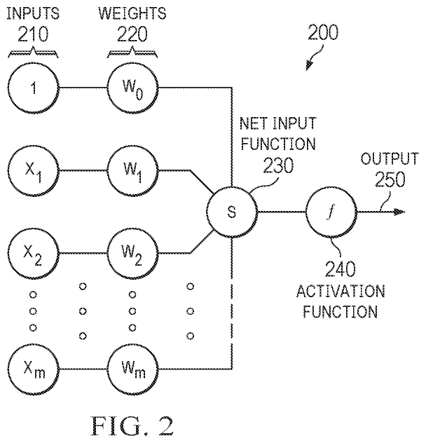

FIG. 2 depicts a diagram illustrating a node in a neural network with which illustrative embodiments can be implemented. Node (artificial neuron) 200 combines multiple inputs 210 from other nodes. Each input 210 is multiplied by a respective weight 220 that either amplifies or dampens that input, thereby assigning significance to each input for the task the algorithm is trying to learn. The weighted inputs are collected by a net input function 230 and then passed through an activation function 240 to determine the output 250. The connections between nodes are called edges. The respective weights of nodes and edges might change as learning proceeds, increasing, or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between, possibly traversing some or all of the layers multiple times. Each layer's output acts as the next layer's input.

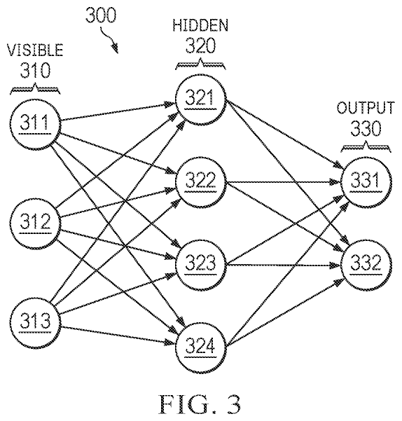

FIG. 3 depicts a diagram illustrating a neural network in which illustrative embodiments can be implemented. As shown in FIG. 3, the nodes in the neural network 300 are divided into a layer of visible nodes 310, a layer of hidden nodes 320, and a layer of output nodes 330. The nodes in these layers might comprise nodes such as node 200 in FIG. 2. The visible nodes 310 are those that receive information from the environment (i.e., a set of external training data). Each visible node in layer 310 takes a low-level feature from an item in the dataset and passes it to the hidden nodes in the next layer 320. When a node in the hidden layer 320 receives an input value x from a visible node in layer 310 it multiplies x by the weight assigned to that connection (edge) and adds it to a bias b. The result of these two operations is then fed into an activation function which produces the node's output.

In fully connected feed-forward networks, each node in one layer is connected to every node in the next layer. For example, node 321 in hidden layer 320 receives input from all of the visible nodes 311, 312, and 313 in visible layer 310. Each input value x from the separate nodes 311-313 is multiplied by its respective weight, and all of the products are summed. The summed products are then added to the hidden layer bias, which is a constant value that is added to the weighted sum to shift the result of the activation function and thereby provide flexibility and prevent overfitting the dataset. The result is passed through the activation function to produce output to output nodes 331 and 332 in output layer 330. A similar process is repeated at hidden nodes 322, 323, and 324. In the case of a deeper neural network, the outputs of hidden layer 320 serve as inputs to the next hidden layer.

Neural network layers can be stacked to create deep networks. After training one neural net, the activities of its hidden nodes can be used as inputs for a higher level, thereby allowing stacking of neural network layers. Such stacking makes it possible to efficiently train several layers of hidden nodes. Examples of stacked networks include deep belief networks (DBN), recurrent neural networks (RNN), convolutional neural networks (CNN), and spiking neural networks (SNN).

Artificial neural networks are configured to perform particular tasks by considering examples, generally without task-specific programming. The process of configuring an artificial neural network to perform a particular task may be referred to as training. An artificial neural network that is being trained to perform a particular task may be described as learning to perform the task in question.

A typical process for training an artificial neural network may include providing an input having a known desired output. The input is propagated through the neural network until an output is produced at the output layer of the network. The output is then compared to the desired output, using a loss function. The resulting error value is calculated for each of the artificial neurons (nodes) in the output layer of the neural network. The error values are then propagated from the output back through the artificial neural network, until each artificial neuron in the network has an associated error value that reflects its contribution to the original output. Backpropagation uses these error values to calculate the gradient of the loss function. This gradient is used by an optimization method to update the weights in the artificial neural network in an attempt to minimize the loss function. This process of propagation and weight update is then repeated for other inputs having known desired outputs.

An artificial neural network may be implemented as a neural network model running on conventional computer processor hardware, such as a central processor unit (CPU) and a graphical processor unit (GPU). Alternatively, an artificial neural network may be implemented on neuromorphic hardware. Neuromorphic hardware may comprise very-large-scale integration (VLSI) systems containing electronic analog circuits that mimic neuro-biological architectures present in the nervous system. Neuromorphic hardware may include analog, digital, mixed-mode analog and digital VLSI, and software systems that implement models of neural systems. Neuromorphic hardware may thus be used to implement artificial neural networks directly in hardware. An artificial neural network implemented in neuromorphic hardware may be faster and more efficient than running a neural network model on conventional computer hardware.

While artificial neural networks (ANNs) can become quite complex, the illustrative embodiments consider that each layer of a neural network effectively has the following form:

$${x}_{B} = f ( {x}_{A} * {W}_{A B} + {b}_{B} )$$

where x_{A} is the activation of neurons in layer A, x_{B} is the activation of neurons in layer B, W_{AB} is the weight matrix, aka synaptic strengths, between A and B, b_{B} is a bias term on each of nodes, and f( ) is the activation function of neurons, such as a ReLU (rectified linear unit) or sigmoid. The illustrative embodiments consider a specific element of W_{AB} as w_{ab}, which is the weight of the connection between node a of A to node b of B.

The vector matrix multiply within the function is, of course, a linear mapping, and while there are some constraints on f, in general the main requirement for ANNs is that it be non-linear and (mostly) differentiable. For most neural networks, the individual element weights of W can be any number, positive or negative, though restricted precision networks begin to introduce constraints in both range and precision of the weights.

The approach the illustrative embodiments take for synapse sampling is to consider W_{AB} as a matrix of probabilities instead of continuous valued weights. This approach requires three modifications of a standard neural network process. First, the weights are restricted in training between 0 and 1, or the network is renormalized (through modifying b and f) to allow weights to be between 0 and 1. Doing so should not have a significant impact on performance for standard activation functions if the weights are allowed arbitrary precision.

Second, after training, the weigh matrix W_{AB} is thus viewed as a probability matrix PAB, wherein the probability of each element being equal to 1 is W_{ab}. For each inference sample, instead of using W the illustrative embodiments instead use a sample matrix S_{AB}, wherein each element s_{ab} is equal to either 1 or 0 with stochastic draw through a weighted coinflip with probability W_{ab} of equaling 1.

Third, the illustrative embodiments run many inference cycles, each with a different S_{AB}. Each sample provides a set of predictions based only on using those weights that were included in that particular sample. The expected value of the matrix multiply x_{A}*S_{AB} is the same as x_{A}*W_{AB}. However, each individual sample of the former will be different.

Calculation of x_{A}*S_{AB} Should be considerably cheaper than x_{A}*W_{AB} because S is binary. The biggest cost of the sampling here would be that modern ANN hardware technologies, such as GPUs and systolic arrays, are not well configured for a rapid in situ sampling (generating a series of different S matrices for each sample). Instead, each S would have to be generated from W at each sampling epoch conventionally, which is a very costly step. However, alternative technologies that use stochastic behavior of, e.g., magnetic tunnel junctions or tunnel diodes, can provide this sampling natively.

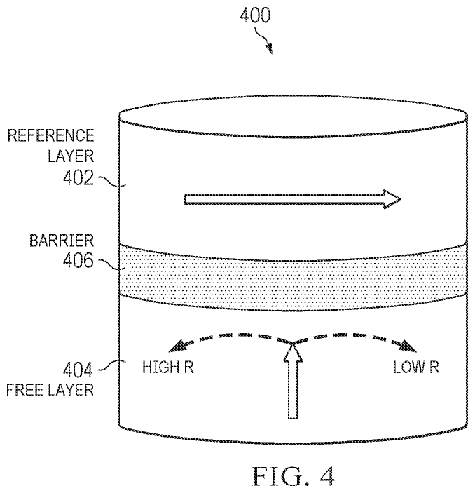

FIG. 4 depicts a diagram of a stochastic magnetic tunnel junction in accordance with an illustrative embodiment. Magnetic tunnel junction (MTJ) 400 is a tunneling device comprising two thin magnetic metal electrodes 402, 404 separated by a thin insulating tunnel barrier 406. MTJ 400 can be readily integrated into back-end-of-line complementary metal-oxide semiconductor (CMOS) manufacturing. MTJ 400 is in the form of a nanopillar with one electrode 402 with fixed magnetic moment and the other electrode 404 with a magnetic moment that is free to reorient. The tunneling resistance depends on the relative alignment of the magnetic moments of the electrodes 402, 404. Anti-alignment produces a high resistance state and parallel alignment produces a low resistance state, with a resistance change of a factor or 2 or 3 commonly realized.

MTJ 400 can also be thought of in terms of a double-well potential, with the x-axis being the magnetization of the free layer electrode 404. In one mode of operation thermal energy can switch the orientation of the free layer electrode 404, an effect known as superparamagnetism, producing two-level resistance fluctuations in the MTJ 400. In a second mode of operation, applied current pulses are used to initialize the free layer electrode 404 into a known unstable magnetic state, which is read out after letting the device relaxes into one of the two stable states.

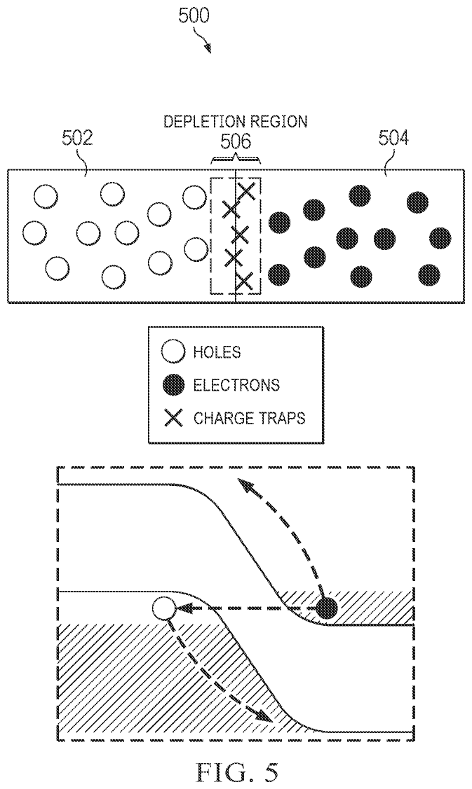

FIG. 5 depicts a depicts a diagram of a stochastic tunnel diode in accordance with an illustrative embodiment. Tunnel diode (TD) 500 comprises a strongly p-type doped region 502 and n-type doped region 504 in a semiconductor, wherein the resulting depletion region 506 between them is very narrow. While large discrete TDs have historically been used in analog high-speed electronics, the illustrative embodiments may employ nanoscale TDs integrated into front-end-of-line CMOS manufacturing for probabilistic computing. TD 500 can conduct the same amount of current either through tunneling or thermionic emission. Which branch the device takes depends on detailed charge occupancy of the defects in the junction and is detected by the TD 500 as a low (tunneling) or high (thermionic emission) voltage.

Conceptually, it is easiest to think of the TD in terms of a double-well potential where the x-axis is the charge occupancy of a single defect. Tuning this device is accomplished with a current pulse that gives the defect an average charge occupancy corresponding to the weight of the coinflip.

Several simple Modified National Institute of Standards and Technology (MNIST)-trained networks were explored using Keras. The model described herein was a simple feedforward network with 784-200-10, with dropout in the hidden layer. The model was trained for weights to be constrained between 0.0 and 1.0, initialized uniformly between 0.25 and 0.75. The hidden layer had a ReLU activation, and the output layer was Softmax. The network was trained for 200 epochs, with a batch size of 80, and achieved a validation set accuracy of 0.9625 and a test set accuracy of 0.9535.

Sampling was performed by changing the weight matrices W between the first (visible) and hidden and hidden and output layers to binary S matrices with each element being 0 or 1 based on a probability draw of s_{ab}=1 with P=w_{ab}. There were 1000 separate sampling experiments. The bias weights were unchanged.

Each sample network, now no longer using W but rather the sampled S, had considerably worse performance on MNIST when predicting the test set. Most prediction accuracies were roughly 0.3, with a few as low as 0.2 and a few as high as 0.5. However, the predictive performance of individual samples is not the primary concern.

To aggregate the sample performance, the predictions of all of the samples were combined. Each sample of the network is considered a ‘vote’ of the test data point's appropriate class. In MNIST, this would result in a given data point having noisy votes from each sample. For instance, a true ‘4’ may get votes for each of the digits (due to vagaries of the synapse sampling), but most votes are expected to be for 4, while the second most votes would be for perhaps 9, and relatively few votes for something like a 2.

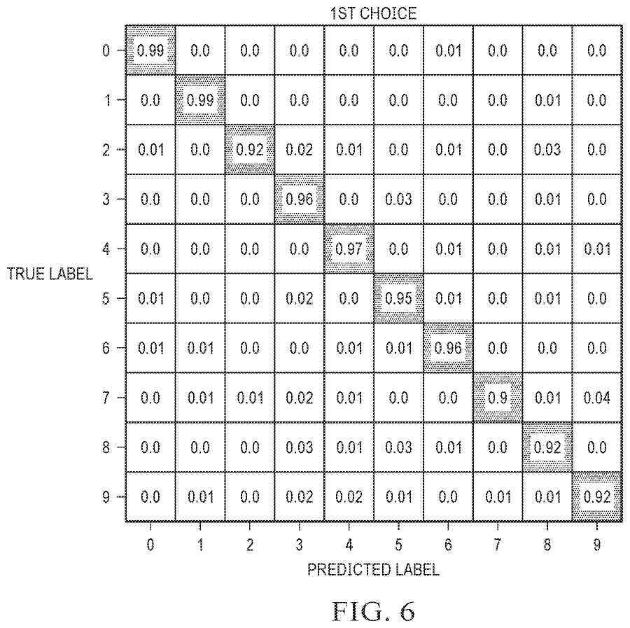

When considering each of the sampled network as getting a vote for test data point predictions, a much stronger performance is observed. As shown in the confusion matrix of first place votes in FIG. 6, the vast majority of digits (approaching original training set accuracy) were voted to be appropriately classified.

This is promising, given that the network was not particularly optimized for any form of synaptic sampling (aside from using dropout) and the relatively low number of samples (only 1000). Sampling asymptotically appears to approach the test accuracy of the original network (0.9535). After 1000 epochs, the sampling accuracy is 0.9478, and the marginal benefit of additional samples appears to saturate around 300 or 400 samples.

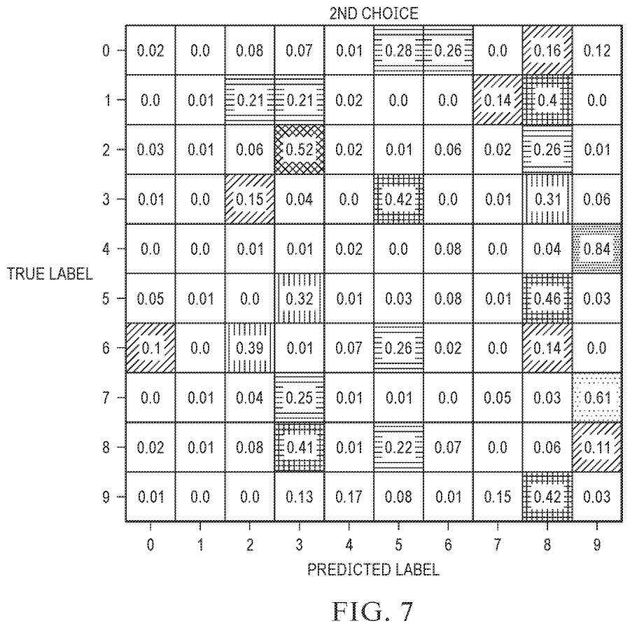

More interesting though is looking at the second place votes, shown in FIG. 7. The second place ranking of votes shows the category, aside from the winner, that the most samples had predicted was the category. (Note: these second place votes are not the second choice of a given sample, but rather the first choice of many of the samples.)

Examining the off-diagonal terms reveals how the networks that voted incorrectly made errors. As would be expected from MNIST intuition, many 4 and 7 data points had a significant number of samples that classified them as a ‘9’. Similar confusion occurred between 2 and 3. Some of these observations are not noticeable in the first-choice errors. For instance, the second choice of many 1s was 7, but there were very few 1s misclassified from the start.

The use of stochastic neuromorphic hardware controls the randomness at the device level, making stochasticity a universal resource. While considering here what can be done with a large number of weighted coin flips, the weighting of that coin likely cannot be arbitrarily set. Rather, the weight will have some precision, and that precision will undoubtedly be lower than the floating point precision typically used in ANN weights.

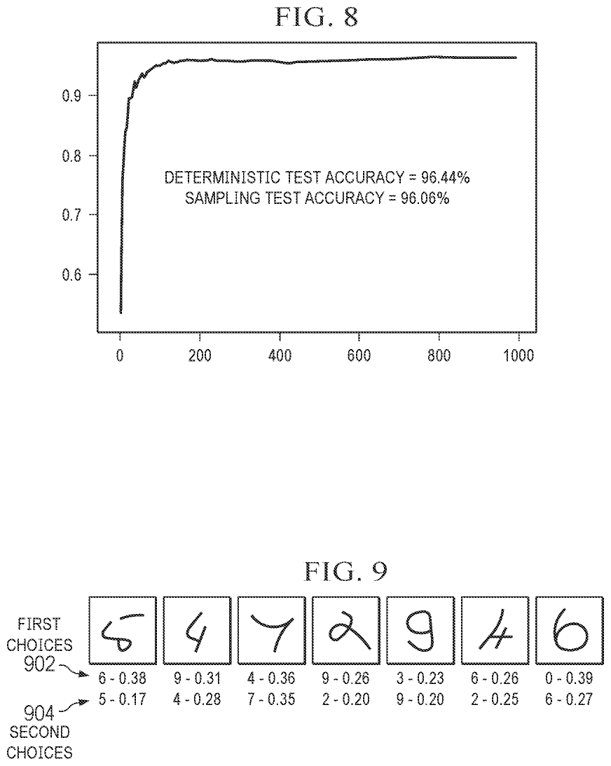

Repeating the experiments from above, but in a slightly different network, using 400 hidden units and 1000 sampling epochs produces a second choice sampling similar to that seen in FIG. 7. This result is not obvious, since the structure of the incorrect choices that primarily constitute the second choices was not part of the training labels. This result suggests that the structure of the sampling distributions is inherent derived from the data itself. With no constraints on sampling precision, the network can get very close (0.9606) to the test accuracy (0.9644), shown in FIG. 8.

Another experiment repeated the same sampling process, but instead of comparing the weights to a computer-precision uniform random number, they were compared to a random number at either 8-bit or 6-bit precision. One thousand samples were run for each of these lower-precision cases, and the accuracy possibly does not fully saturate the performance for the 6-bit case. However, while lower precision (6-bit) does have a noticeable impact on accuracy, the overall trends of the results are promising, and the 8-bit case does not show any significant impairment of precision. In particular, the results show that considerably lower precision networks (6-bit) still maintain some of their classification ability. While more work is required, the shape of the approximation curve suggests that it is possible a significant part of the remaining error can be mitigated by adding more samples.

FIG. 9 depicts a diagram of wrong inference choices in accordance with an illustrative embodiment. Looking at a few specific examples of MNIST examples that are misclassified, it can be seen there are a number of difficult examples (for small feed forward networks) that are misclassified. As can be seen by these examples, the classification that receives the second most votes is often the correct one.

These results support the idea that sampling can be performed on ANNs, that the approach is not overly prohibitive (can achieve near deterministic accuracy with 1000 samples) and appear to offer something beyond a straight deterministic solution in looking a distribution of ‘sample votes’.

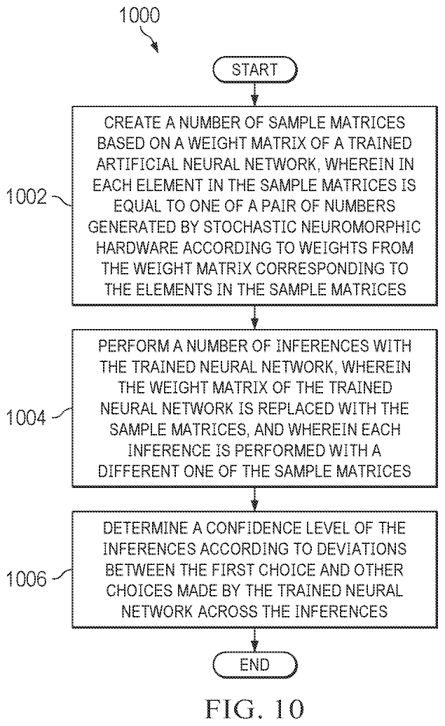

FIG. 10 depicts a flowchart illustrating a process for sampling a trained neural network in accordance with illustrative embodiments. Process 1000 might be implemented in neural network sampling system 100 shown in FIG. 1 using ANNs such as ANN 300 shown in FIG. 3.

Process 1000 begins by creating a number of sample matrices based on a weight matrix of a trained artificial neural network (step 1002). In each element in the sample matrices is equal to one of a pair of numbers generated by stochastic neuromorphic hardware according to weights from the weight matrix corresponding to the elements in the sample matrices. The pair of numbers generated by the stochastic neuromorphic hardware may comprise, e.g., 1 and 0, or −1 and 1. The stochastic neuromorphic hardware may comprise, e.g., magnetic tunnel junctions or tunnel diodes. The pair of numbers generated by the stochastic neuromorphic hardware may correspond, respectively, to a low resistance state and a high resistance state of a stochastic device.

The stochastic neuromorphic hardware may use the weights from the weight matrix directly as probabilities of the corresponding elements in the sample matrices being one of the pair of numbers. For example, if the weights are bounded between 0 and 1. Alternatively, the stochastic neuromorphic hardware may use the weights from the weight matrix indirectly to compute probabilities of the corresponding elements in the sample matrices being one of the pair of numbers. In such a case, the weights might be distributed in larger ranges which are converted into matrix probabilities.

Process 1000 then performs a number of inferences with the trained neural network, wherein the weight matrix of the trained neural network is replaced with the sample matrices, and wherein each inference is performed with a different one of the sample matrices (step 1004). The inferences may be performed in parallel.

Process 1000 then determines a confidence level of the inferences according to deviations between the first choice and other choices made by the trained neural network across the inferences (step 1006). For the total number of inferences, the trained neural network picks each potential choice a number of times. The confidence level of the inferences may be determined by dividing the number of times the first choice classification is picked by the total number of inferences. The resulting percentage may be compared to a specified threshold (e.g., 80% or 90%). For example, if the first choice among the total number of inferences is only 38%, the confidence level in that choice would be unacceptable, warranting additional training of the neural network.

Process 1000 then ends.

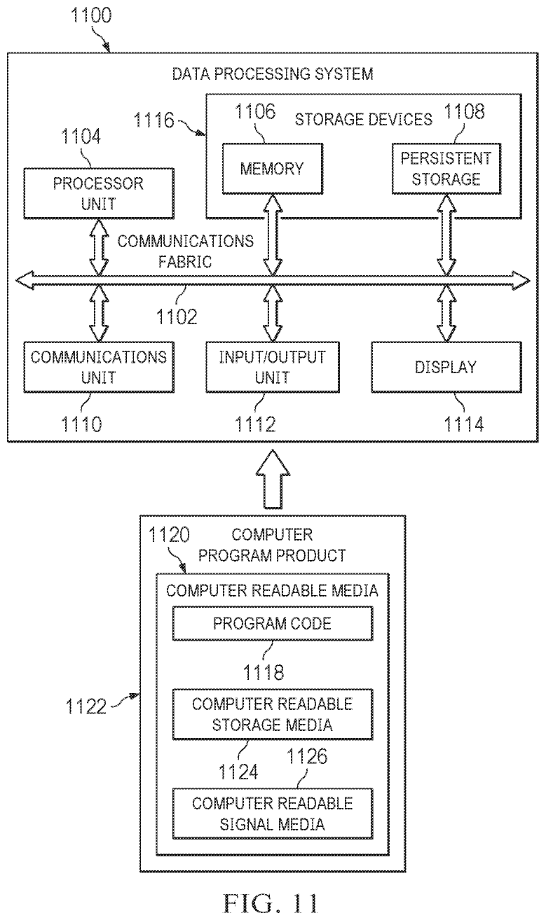

Turning now to FIG. 11, an illustration of a block diagram of a data processing system is depicted in accordance with an illustrative embodiment. Data processing system 1100 may be used to neural network sampling system 100 in FIG. 1. In this illustrative example, data processing system 1100 includes communications framework 1102, which provides communications between processor unit 1104, memory 1106, persistent storage 1108, communications unit 1110, input/output unit 1112, and display 1114. In this example, communications framework 1102 may take the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (GPUs).

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1116, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1118 may be transferred to data processing system 1100 using computer-readable signal media 1126. Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implement method of sampling an artificial neural network, the method comprising:
using a number of processors to perform the steps of:
creating a number of sample matrices based on a weight matrix of a trained artificial neural network, wherein each element in the sample matrices is equal to one of a pair of numbers generated by stochastic neuromorphic hardware according to weights from the weight matrix corresponding to the elements in the sample matrices;
performing a number of inferences with the trained neural network, wherein the weight matrix of the trained neural network is replaced with the sample matrices, and wherein each inference is performed with a different one of the sample matrices; and
determining a confidence level of the inferences according to deviations between the first choice and other choices made by the trained neural network across the inferences.

2. The method of claim 1, wherein the pair of numbers generated by the stochastic neuromorphic hardware comprises:
1 and 0; or
−1 and 1.

3. The method of claim 1, wherein the stochastic neuromorphic hardware uses the weights from the weight matrix as probabilities of the corresponding elements in the sample matrices being one of the pair of numbers.

4. The method of claim 1, wherein the stochastic neuromorphic hardware uses the weights from the weight matrix to compute probabilities of the corresponding elements in the sample matrices being one of the pair of numbers.

5. The method of claim 1, wherein the weights in the weight matrix are constrained between 0 and 1.

6. The method of claim 1, wherein the inferences are performed in parallel.

7. The method of claim 1, wherein the stochastic neuromorphic hardware comprises magnetic tunnel junctions.

8. The method of claim 1, wherein the stochastic neuromorphic hardware comprises tunnel diodes.

9. The method of claim 1, wherein the pair of numbers generated by the stochastic neuromorphic hardware correspond, respectively, to a low resistance state and a high resistance state of a stochastic device.

10. A system for sampling an artificial neural network, the system comprising:
a storage device configured to store program instructions; and
one or more processors operably connected to the storage device and configured to execute the program instructions to cause the system to:
create a number of sample matrices based on a weight matrix of a trained artificial neural network, wherein each element in the sample matrices is equal to one of a pair of numbers generated by stochastic neuromorphic hardware according to weights from the weight matrix corresponding to the elements in the sample matrices;
perform a number of inferences with the trained neural network, wherein the weight matrix of the trained neural network is replaced with the sample matrices, and wherein each inference is performed with a different one of the sample matrices; and
determine a confidence level of the inferences according to deviations between the first choice and other choices made by the trained neural network across the inferences.

11. The system of claim 10, wherein the pair of numbers generated by the stochastic neuromorphic hardware comprises:
1 and 0; or
−1 and 1.

12. The system of claim 10, wherein the stochastic neuromorphic hardware uses the weights from the weight matrix as probabilities of the corresponding elements in the sample matrices being one of the pair of numbers.

13. The system of claim 10, wherein the stochastic neuromorphic hardware uses the weights from the weight matrix to compute probabilities of the corresponding elements in the sample matrices being one of the pair of numbers.

14. The system of claim 10, wherein the weights in the weight matrix are constrained between 0 and 1.

15. The system of claim 10, wherein the inferences are performed in parallel.

16. The system of claim 10, wherein the stochastic neuromorphic hardware comprises magnetic tunnel junctions.

17. The system of claim 10, wherein the stochastic neuromorphic hardware comprises tunnel diodes.

18. The system of claim 10, wherein the pair of numbers generated by the stochastic neuromorphic hardware correspond, respectively, to a low resistance state and a high resistance state of a stochastic device.

19. A computer program product for sampling an artificial neural network, the computer program product comprising:
a computer-readable storage medium having program instructions embodied thereon to perform the steps of:
creating a number of sample matrices based on a weight matrix of a trained artificial neural network, wherein each element in the sample matrices is equal to one of a pair of numbers generated by stochastic neuromorphic hardware according to weights from the weight matrix corresponding to the elements in the sample matrices;
performing a number of inferences with the trained neural network, wherein the weight matrix of the trained neural network is replaced with the sample matrices, and wherein each inference is performed with a different one of the sample matrices; and
determining a confidence level of the inferences according to deviations between the first choice and other choices made by the trained neural network across the inferences.

20. The computer program product of claim 19, wherein the pair of numbers generated by the stochastic neuromorphic hardware comprises:
1 and 0; or
−1 and 1.

21. The computer program product of claim 19, wherein the stochastic neuromorphic hardware uses the weights from the weight matrix as probabilities of the corresponding elements in the sample matrices being one of the pair of numbers.

22. The computer program product of claim 19, wherein the stochastic neuromorphic hardware uses the weights from the weight matrix to compute probabilities of the corresponding elements in the sample matrices being one of the pair of numbers.

23. The computer program product of claim 19, wherein the weights in the weight matrix are constrained between 0 and 1.

24. The computer program product of claim 19, wherein the inferences are performed in parallel.

25. The computer program product of claim 19, wherein the stochastic neuromorphic hardware comprises magnetic tunnel junctions.

26. The computer program product of claim 19, wherein the stochastic neuromorphic hardware comprises tunnel diodes.

27. The computer program product of claim 19, wherein the pair of numbers generated by the stochastic neuromorphic hardware correspond, respectively, to a low resistance state and a high resistance state of a stochastic device.
